(19) United States
(12) Patent Application Publication
(10) Pub. No.: US 2025/0109913 A1
(43) Pub. Date: Apr. 3, 2025

(54) THERMAL ENERGY STORAGE SYSTEMS INCLUDING ANISOTROPIC THERMAL CONDUCTIVE CARBON FIBERS FOR ENHANCING THERMAL EFFICIENCY OF PHASE CHANGE MATERIALS

(71) Applicant: UT-Battelle, LLC, Oak Ridge, TN (US)

(72) Inventors: Xinzhang Zhou, Oak Ridge, TN (US); Xiaobing Liu, Oak Ridge, TN (US); Amit K. Naskar, Oak Ridge, TN (US); Lingshi Wang, Oak Ridge, TN (US)

(21) Appl. No.: 18/882,209

(22) Filed: Sep. 11, 2024

Related U.S. Application Data
(60) Provisional application No. 63/541,110, filed on Sep. 28, 2023.

(51) Int. Cl. F28D 20/00

(52) U.S. Cl. CPC F28D 20/0056; F28D 2020/0017; F28D 2020/0078

(57) ABSTRACT

A thermal energy storage composition is provided. The composition includes a phase change material and a plurality of long, anisotropic thermal conductive carbon fibers mixed with the phase change material. The anisotropic thermal conductive carbon fibers enhance heat transfer and accelerate phase change of the phase change material to increase the thermal storage efficiency of the composition. The anisotropic thermal conductive carbon fibers may be present in an amount of up to 5% by weight, and may have a length in the range of 1 to 10 cm. The anisotropic thermal conductive carbon fibers also may have a greater thermal conductivity in an axial direction relative to a thermal conductivity in a radial direction. A thermal energy storage system including the thermal energy storage composition and a method of heat management in a thermal energy storage system are also provided.

### CROSS-REFERENCE TO RELATED APPLICATIONS

This application claims the benefit of U.S. Provisional Application No. 63/541,110, filed Sep. 28, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to thermal energy storage, and more particularly to enhancing the thermal efficiency of phase change materials used in thermal energy storage systems.

### BACKGROUND OF THE INVENTION

Currently around 4,000 billion kilowatt hours of electricity is consumed per year, and maintaining the temperature (heating and cooling) of buildings accounts for 13% of the total electricity consumption in the United States. Thermal management systems can be designed to incorporate distributed assets such as solar panels and wind generating units to manage energy demand, utilizing thermal storage systems which allow overproduced renewable power to be stored for later use. Thermal energy can be stored by using several technologies; however, the primary means is through the use of phase change materials (PCMs), which have a high ratio of latent heat to sensible heat within a specific temperature change. For example, an underground thermal battery has been developed to provide diurnal thermal energy storage in conjunction with a dual-source heat pump system, employing a PCM to further enhance its storage capacity. The thermal energy is stored during daytime when temperatures are high and subsequently released during night when temperatures are low. Such thermal energy management helps to lower energy consumption and thus the utility costs for building owners and occupants.

However, inorganic PCMs typically have a low thermal conductivity, such as 0.5 W/m·K, and organic PCMs typically have an even lower thermal conductivity, such as 0.2 W/m·K, Due to the low thermal conductivities of PCMs, a large temperature difference between the heat carrier fluid (heat exchange medium) and the PCM is required to enable phase change at the desired speed, directly resulting in slow phase change (charge and discharge) and/or incomplete phase change and thus low thermal efficiency of the thermal energy storage system.

Therefore, efforts have been made to improve the thermal performance of the PCMs. For example, micro-encapsulation of PCMs in conductive microparticles or macro-encapsulation of PCMs in the pores of conductive metal or graphite foams can enhance heat transfer properties by increasing the specific surface area (heat transfer area) without changing the intrinsic properties of PCMs. The improvement of heat transfer properties via encapsulation method and the use of three-dimensional foam, however, is limited since latent heat capacity is proportional to the total PCM volume ratio. Alternatively, the addition of materials with high thermal conductivity, including metal, ceramic, or graphite whiskers, particles, and flakes, also increases the heat transfer within PCMs. However, to avoid sedimentation, these additives must be in micrometer sizes in the range of 0.01 to 100 μm. The results indicate that the bulk thermal conductivities of such composite materials are higher than those of the corresponding pure PCMs. However, such thermally conductive additives only change the thermal transfer locally in the micrometer size range. Thus, the phase change front interfaces still follow the PCM container shapes, as in pure PCMs.

Hence, a need exists for phase change materials and thermal energy storage compositions having enhanced thermal energy efficiency while overcoming the disadvantages of conventionally enhanced phase change materials.

### SUMMARY OF THE INVENTION

A thermal energy storage composition is provided. The composition includes a phase change material and a plurality of long, anisotropic thermal conductive carbon fibers mixed with the phase change material. The anisotropic thermal conductive carbon fibers enhance heat transfer and accelerate phase change of the phase change material to increase the thermal storage efficiency of the composition.

In specific embodiments, the phase change material is present in an amount of at least 95% by weight (wt. %).

In specific embodiments, the anisotropic thermal conductive carbon fibers are present in an amount of up to 5% by weight (wt. %).

In specific embodiments, the anisotropic thermal conductive carbon fibers have a length in the range of 1 to 10 cm.

In specific embodiments, the phase change material has a thermal conductivity in the range of 0.1 to 0.6 W/(m·K).

In particular embodiments, the thermal conductivity of the composition is greater than the thermal conductivity of the phase change material.

In specific embodiments, the anisotropic thermal conductive carbon fibers have a greater thermal conductivity in an axial direction relative to a thermal conductivity in a radial direction.

In particular embodiments, the thermal conductivity in the axial direction is in a range of 2-200 W/(m·K), and the thermal conductivity in the radial direction is in a range of 0.5-50 W/(m·K).

In particular embodiments, the thermal conductivity in the axial direction is approximately 2-10 times greater than the thermal conductivity in the radial direction.

In specific embodiments, the phase change material is an organic phase change material or an inorganic phase change material.

A thermal energy storage system is also provided. The system includes a container, a phase change material disposed within the container, and a plurality of long, anisotropic thermal conductive carbon fibers mixed with the phase change material in the container. The anisotropic thermal conductive carbon fibers increase the effective thermal conductivity of the system, thereby accelerating phase change of the phase change material to reduce charge and discharge times of the thermal storage system.

In specific embodiments, the phase change material and or the anisotropic thermal conductive carbon fibers may have one or more of the same features described above.

In specific embodiments, the container is cylindrical in shape.

In specific embodiments, the container storing the phase change material and anisotropic thermal conductive carbon fibers defines a module, and the thermal energy storage system comprises a plurality of the modules.

In specific embodiments, a working temperature of the system is in a range of from −50° C. to 700° C.

A method of heat management in a thermal energy storage system is also provided. The method includes providing the thermal energy storage composition in any of the embodiments described above. The method further includes disposing the thermal energy storage composition within a container. The method further includes flowing a heat exchange medium over the container, wherein thermal energy is exchanged between the heat exchange medium and the thermal energy storage composition. The anisotropic thermal conductive carbon fibers increase the effective thermal conductivity of the mixture, thereby accelerating phase change of the phase change material to reduce charge and discharge times of the thermal storage system, which results in improved thermal efficiency of the system.

These and other features of the invention will be more fully understood and appreciated by reference to the description of the embodiments and the drawings.

### BRIEF DESCRIPTION OF THE DRAWINGS

FIG. 1 is a schematic illustration of heat flux through anisotropic carbon fibers in comparison to isotropic carbon fibers;

FIG. 2 is a graph of the temperature profile for solidification of inorganic phase change materials with and without long, anisotropic thermal conductive carbon fibers;

FIG. 3 is a graph of the temperature profile for solidification of organic phase change materials with and without long, anisotropic thermal conductive carbon fibers;

FIG. 4 is a graph of the temperature profile for melting of inorganic phase change materials with and without long, anisotropic thermal conductive carbon fibers;

FIG. 5 is a graph of the temperature profile for melting of organic phase change materials with and without long, anisotropic thermal conductive carbon fibers;

FIG. 6 is a graph of the temperature profile of environmental water temperature surrounding a thermal energy storage system during melting of inorganic phase change materials with and without long, anisotropic thermal conductive carbon fibers;

FIG. 7 is a graph of the temperature profile of environmental water temperature surrounding a thermal energy storage system during melting of organic phase change materials with and without long, anisotropic thermal conductive carbon fibers;

FIG. 8 is a graph of charging temperature profiles for inorganic phase change materials with and without carbon fibers and at various carbon fiber loadings; and

FIG. 9 is a graph of discharging temperature profiles for inorganic phase change materials with and without carbon fibers and at various carbon fiber loadings;

FIG. 10 is a graph of charging temperature profiles for organic phase change materials with and without carbon fibers and at various carbon fiber loadings; and

FIG. 11 is a graph of discharging temperature profiles for organic phase change materials with and without carbon fibers and at various carbon fiber loadings.

### DETAILED DESCRIPTION OF THE CURRENT EMBODIMENTS

A thermal energy storage composition, a thermal energy storage system, and a method of heat management in a thermal energy storage system are provided. The composition, system, and method enhance the effective thermal conductivity of phase change materials while not encountering the disadvantages of conventional ways of raising the thermal efficiency of phase change materials. The thermal energy storage composition is suitable in a variety of applications including, but not limited to, any application in which thermal energy storage is desirable.

The thermal energy storage composition includes a phase change material. The phase change material is the primary constituent of the composition and may be present in an amount of 95 wt. % or greater based on the total weight of the thermal energy storage composition. Thus, in some embodiments the phase change material is present in an amount of at least 95 wt. %, optionally at least 96 wt. %, optionally at least 97 wt. %, optionally at least 98 wt. %, or optionally at least 99 wt. %. In other embodiments, the phase change material may be present in an amount less than 95 wt. %, for example at least 85 wt. %, alternatively at least 90 wt. %, alternatively at least 91 wt. %, alternatively at least 92 wt. %, alternatively at least 93 wt. %, alternatively at least 94 wt. %. The phase change material may be an organic phase change material or an inorganic phase change material, and may have a thermal conductivity of at least 0.1 W/(m·K), optionally in the range of 0.1 to 0.6 W/(m·K), optionally in the range of 0.2 to 0.6 W/(m·K), optionally in the range of 0.3 to 0.6 W/(m·K), optionally in the range of 0.4 to 0.6 W/(m·K), optionally in the range of 0.5 to 0.6 W/(m·K), optionally in the range of 0.1 to 0.5 W/(m·K), optionally in the range of 0.1 to 0.4 W/(m·K), optionally in the range of 0.1 to 0.3 W/(m·K), optionally in the range of 0.1 to 0.2 W/(m·K). Further, the phase change material may be a single phase change material component or a combination of two or more phase change material components, such as a combination of organic phase change material components, a combination of inorganic phase change material components, or a combination of organic and inorganic phase change material components. By way of example, suitable phase change material component(s) include but are not limited to inorganic salt hydrates such as but not limited to lithium chlorate trihydrate (LiClO₃·3H₂O), dipotassium hydrogen phosphate hexahydrate (K₂HPO₄·6H₂O), potassium fluoride tetrahydrate (KF·4H₂O), manganese nitrate hexahydrate (Mn(NO₃)₂·6H₂O), calcium chloride hexahydrate (CaCl₂·6H₂O), sodium sulfate decahydrate (Na₂SO₄·10H₂O), sodium hydrogen phosphate dodecahydrate (Na₂HPO₄×12H₂O), zinc nitrate hexahydrate (Zn(NO₃)₂6H₂O), iron (III) chloride hexahydrate (FeCl₃·6H₂O), calcium chloride tetrahydrate (CaCl₂·4H₂O), calcium nitrate tetrahydrate (Ca(NO₃)₂·4H₂O), calcium bromide hexahydrate (CaBr₂·6H₂O), sodium thiosulfate pentahydrate (Na₂S₂O₃·5H₂O), and sodium acetate trihydrate (C₂H₃NaO₂·3H₂O), or combinations of salt hydrate materials such as but not limited to sodium carbonate decahydrate+disodium phosphate dodecahydrate (Na₂CO₃·10H₂O+Na₂HPO₄·12H₂O), calcium chloride hexahydrate+calcium bromide hexahydrate (CaCl₂·6H₂O+CaBr₂·6H₂O), sodium sulfate decahydrate+sodium biphosphate dodecahydrate (Na₂SO₄·10H₂O+Na2HPO₄·12H₂O), sodium carbonate decahydrate+sodium biphosphate dodecahydrate (Na₂CO₃·10H₂O+Na₂HPO₄·12H₂O). Further, suitable phase change material component(s) also include but are not limited to organic materials including paraffins (e.g. higher alkanes such as, octadecane, nonadecane, icosane, docosane) or paraffin wax blends, fatty acids and esters, and alcohols (e.g., erythritol).

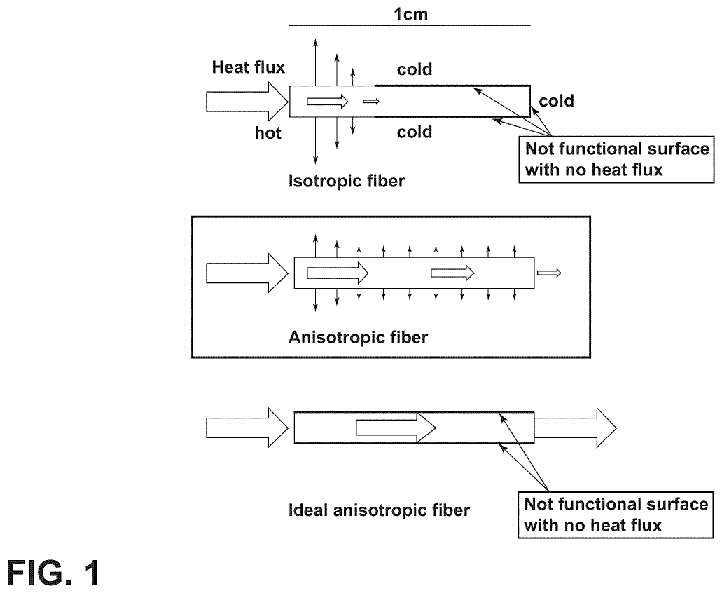

The thermal energy storage composition also includes, in addition to the phase change material, a plurality of long, anisotropic thermal conductive carbon fibers that are mixed with, dispersed, and/or otherwise inserted in the phase change material. By “long,” the carbon fibers typically and as an exemplary embodiment, have a fiber length in the range of 1 to 10 cm, although it should be understood that fibers that are slightly shorter (e.g., 0.5 cm) or slightly longer (e.g., 11 cm) are within the scope of the disclosure. In contrast, the metal, ceramic, or graphite whiskers, particles, and flakes used in conventional mixtures have a significantly shorter length (or other relevant dimension, e.g. radius, width, or the like) in the range of 0.01 to 100 μm. The carbon fibers exhibit thermal conductivity anisotropy, i.e. the thermal conductivity property of the carbon fibers is anisotropic. Particularly, as shown schematically in FIG. 1, the thermal conductivity of the anisotropic carbon fibers is greater in the axial direction (along the longitudinal axis) than in the radial direction (along radii of the carbon fiber). In contrast, isotropic thermal conductive fibers have a thermal conductivity that is essentially the same in the axial direction as the radial direction. In some embodiments, the present anisotropic thermal conductive carbon fibers may be highly anisotropic, such that the carbon fibers have a high thermal conductivity in the axial direction and essentially zero or approaching zero thermal conductivity in the radial direction. Unlike conventional short (micro-scale) whiskers which have a limited temperature difference between their axial ends and thus a small heat flux, the present long anisotropic carbon fibers have larger temperature differences between their axial ends and have a controllable temperature gradient along their fiber axes and thus a greater heat flux. Thus, the surfaces (both cylindrical, side surface and end surfaces) of the long anisotropic carbon fibers act as phase change interfaces to enable latent heat transfer between the phase change material and the heat exchange medium (see below) across a large volume. The phase change fronts occur along essentially the entire length of the long carbon fiber surfaces, across a mark larger area during the phase change (charge, discharge) period, than with conventional additives such as the “one-dimensional” whiskers, “zero-dimensional” particles, and small “two-dimensional” flakes. Further, unlike isotropic fibers, the anisotropic thermal conductive carbon fibers function as a heat tunnel with well-dissipated heat flux radially along its fiber axis, with the whole length of the fiber being thermally functional in effective heat transfer of latent heat. Hence, long anisotropic carbon fibers more effectively transfer heat in the phase change material. In specific embodiments, the present long anisotropic carbon fibers have a thermal conductivity in the axial direction that is in a range of 2-200 W/(m·K), and the long anisotropic carbon fibers have a thermal conductivity in the radial direction that is in a range of 0.5-50 W/(m·K). In other similar embodiments, the thermal conductivity in the axial direction may be approximately 2-10 times greater than the thermal conductivity in the radial direction, optionally 3 times greater, optionally 5 times greater, optionally 7 times greater, optionally 8 times greater, optionally 9 times greater, optionally 9.5 times greater, optionally 10.5 times greater, optionally 11 times greater, optionally 12 times greater, optionally 13 times greater, optionally 15 times greater. Stated differently, the thermal conductivity in the radial direction may be approximately 0.1 (i.e., 10%; kᵣₐₜᵢₒ (thermal conductivity ratio in radial direction over axial direction) equal to 0.1) of the thermal conductivity in the axial direction, optionally 0.05, optionally 0.07, optionally 0.08, optionally 0.09, optionally 0.095, optionally 0.105, optionally 0.11, optionally 0.12, optionally 0.13, optionally 0.15, optionally 0.20, optionally 0.25, optionally 0.33.

The anisotropic thermal conductive carbon fibers may be present in an amount of up to 5 wt. % (i.e., in the range of greater than 0 to less than or equal to 5 wt. %) based on the total weight of the thermal energy storage composition, optionally up to 1 wt. %, optionally up to 2 wt. %, optionally up to 3 wt. %, or optionally up to 4 wt. %. In other embodiments, the anisotropic thermal conductive carbon fibers may be present in an amount greater than 5 wt. %, for example up to 6 wt. %, alternatively up to 7 wt. %, alternatively up to 8 wt. %, alternatively up to 9 wt. %, alternatively up to 10 wt. %. Due to the low content of the anisotropic thermal conductive carbon fibers, the phase change material content remains high, and the total latent heat of the thermal energy storage composition is not greatly affected by the addition of the present carbon fibers. The anisotropic thermal conductive carbon fibers may be, for example, a polyacrylonitrile (PAN)-based carbon fiber in 6K or 12K filament count tows. By way of non-limiting example such PAN-based carbon fibers include but are not limited to lengths of HM63 carbon fibers or IM7 carbon fibers both available from Hexcel Corporation. However, it should be understood that other anisotropic carbon fibers, including PAN-based carbon fibers other than these specific examples, are within the scope of the disclosure.

A thermal energy storage system in accordance with embodiments of the disclosure include the thermal energy storage composition described above disposed within and/or otherwise contained in a container such as a cylindrically-shaped can/tube or other suitable vessel such as but not limited to a pouch. By way of example only, the container may be a hollow cylinder having a diameter of 2 inches and a length of 3 feet. In some embodiments, the system may include a single container, while in other preferable embodiments the system includes a plurality of the containers. In other words, the container storing the phase change material and anisotropic thermal conductive carbon fibers may define a module, and the thermal energy storage system may include a plurality of these modules, such as, for example, 48 modules. Additionally, these 48 modules may constitute a thermal storage battery pack, and the system may include more than one, such as from two to five of these thermal storage battery packs. A working temperature of the system may be in a range of from −50° C. to 700° C. In use, a flow of heat exchange medium (fluid) is passed over the container(s), and thermal energy is exchanged between the heat exchange medium and the thermal energy storage composition. This thermal energy is stored in and released from the system by phase change of the phase change material composition (charge and discharge). The working temperature of the system is generally the temperature at which the phase change material composition changes phase, typically from solid to liquid or liquid to solid.

Inclusion of the long, anisotropic thermal conductive carbon fibers with the phase change material enhances the thermal conductivity of the composition, thereby increasing the effective thermal conductivity of the phase change material and the thermal energy storage system including the composition. The carbon fibers thus increase the thermal storage efficiency of the composition/system by accelerating phase change of the phase change material, thereby increasing the rate of (i.e., reducing the time to complete) charge and discharge of the thermal storage system.

In certain embodiments, the phase change material composition may further include other additives such as a thickener, stabilizer, and/or nucleating agent.

### EXAMPLES

The present method is further described in connection with the following laboratory examples, which are intended to be non-limiting.

The impacts of adding chopped centimeter-long Hexcel IM7 carbon fibers (CFs) in one inorganic phase change material (IPCM) and one organic phase change material (OPCM) was tested to illustrate the effects on both the solidification and melting processes of the materials. Temperatures at the center of the PCMs were measured as an indicator of the solidification and melting processes.

A calcium bromide inorganic phase change material (IPCM) acquired from Insolcorp, LLC, as well as CrodaTherm 5, an organic phase change material (OPCM) acquired from Croda Energy Technologies, were used as the phase change materials. The thermophysical properties of these PCMs are listed in Table 1 below.

TABLE 1
Thermophysical properties of organic and inorganic PCMs

| | | | | | | Phase change |
|---|---|---|---|---|---|---|
| | | k | Cp | | Latent heat | temperature |
| Material | ρ (kg/m³) | (W/(m · K)) | (kJ/kg · K) | η (Pa · s) | (kJ/kg) | (° C.) |
| Inorganic PCM solid | 1760 | 1.09 | 3.41 | N/A | 207 | 8-13 |
| Inorganic PCM liquid | 1760 | 0.54 | 3.41 | 15.2 | | |
| Organic PCM solid | 924 | 0.23 | 1.80 | N/A | 190 | 4 |
| Organic PCM liquid | 870 | 0.15 | 1.70 | 8.2 · 10⁻³ | | |

IM7 and HM63 manufactured by Hexcel Corporation and P55 by Solvay S. A. were obtained as the long anisotropic thermal conductive carbon fibers, and P55 by Solvay S. A. was obtained as a comparative example of an isotropic carbon fiber. The thermal properties of IM7, HM63 and P55 as well as AS4 (also manufactured by Hexcel Corporation) are listed in Table 2 below. The axial thermal conductivity of IM7, AS4, HM63 and P55 were measured and the radial thermal conductivity was estimated from theoretical calculations of graphite crystal properties.

TABLE 2
Thermophysical properties of long carbon fibers

| | | Thermal | Heat | | Thermal |
|---|---|---|---|---|---|
| | Density | conductivity | capacity | Fiber | performance |
| | ρ | k | Cp | Diameter | improvement |
| Material | (kg/m₃) | (W/(m · K) | (kJ/(kg · K)) | (μm) | in PCM |
| IM7 CF | 1780 | 5.4 (axial) | 0.8 | 5.2 | Effective |
| | | 0.5 (radial) | | | |
| HM63 | 1810 | 55 (axial) | 0.8 | 4.9 | Very effective |
| | | 5.5 (radial) | | | |
| P55 | 2000 | 120 (axial | 0.7 | 10 | Not effective |
| | | and radial) | | | |

The tests with the IPCM were conducted in plastic tubes having a height of 10 cm and a diameter of 1.3 cm, and the tests with the OPCM were conducted in glass tubes having a height of 10 cm and a diameter of 2.8 cm. The IM7 carbon fibers (CFs) were cut with stainless steel scissors into 1 cm lengths. The CFs were loaded at 1 wt. % into the liquid PCMs at room temperature. The fibers were well-mixed into the PCMs by placing the tubes into an ultrasonic bath for 10 minutes. A type T thermocouple was inserted through a rubber cap into each tube and the tip of the thermocouple was fixed at the center of the liquid PCMs with a plastic strut. An Omega HH520 datalogger was used to record the PCM temperatures measured in the tubes every 5 seconds. A PolyScience 8106A11B 13-liter Standard Digital Controller Heated Circulating Bath was used to induce phase change from liquid to solid phases. Samples were submerged into the water bath at room temperature and then chilled to below the freezing temperatures of both PCMs (4° C. for IPCM and 2° C. for OPCM). The low temperature was maintained overnight to ensure samples were completely frozen. The melting test was then performed in an insulated beaker containing 300 mL of water at room temperature, with the water level roughly the same as the PCM level inside the tube. Three temperatures were recorded during this study: at the center of the sample, in the water in the beaker, and on the exterior tube wall. The water in the beaker was magnetically stirred at the same level during the test so that the temperature difference in the beaker water was minimized. The top, bottom and side of the beaker and the top of the PCM tube were covered with insulation cloth.

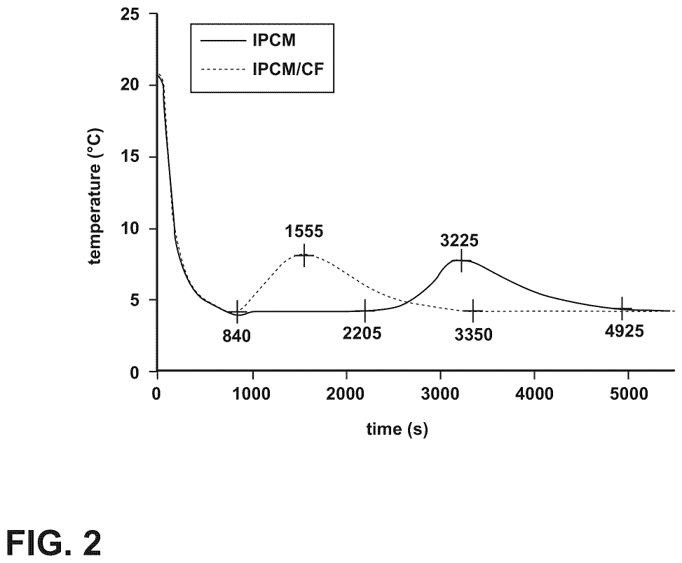

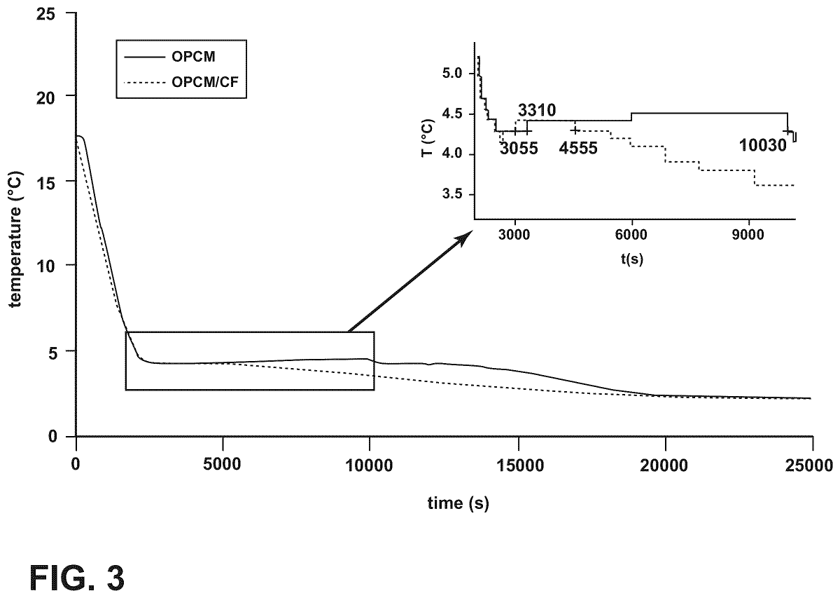

The temperatures at the center of PCMs both with the long, anisotropic thermal conductive carbon fibers (present embodiments) and without carbon fibers (comparative examples) were measured during solidification of the PCMs from 20° C. to 4° C. The results are shown in FIG. 2 (IPCMs) and FIG. 3 (OPCMs). As can be seen from the graphs, both IPCM and ICPM/CF began freezing (displaying a decrease in cooling rate) around 8° C. After cooling beyond 4° C., recalescence peaks appear in both plots, indicating latent heat release during the crystallization process. These peaks can be used to estimate both the starting and ending times of solidification, which are shown in the graphs. The onset, peak, and termination times of the coalescence peaks are marked with the time labels for both IPCM and IPCM/CF temperature profiles in FIG. 2. The recalescence peak for IPCM/CF started about 1700 seconds earlier and ended about 2000 seconds earlier than that for pure IPCM. Particularly, the recalescence peak for IPCM/CF started about 1365 (i.e., 2205 minus 840) seconds earlier, peaked 1670 (i.e., 3225 minus 1555) seconds earlier, and ended about 2720 (i.e., 4925 minus 2205) seconds earlier than that for pure IPCM. The faster crystallization of the IPCM containing carbon fibers (IPCM/CF) can be explained by the large surface area of the present carbon fibers which acted as nucleation sites, triggering the crystallization process much earlier. The surface area of the carbon fiber is about 1 m²/g and in this case 0.16 g of the carbon fiber inserted in the IPCM and 0.43 g of the carbon fiber inserted into in OPCM should have 1600 cm² and 4300 cm² of surface area, respectively. Compared to the container surface area of 29 cm² for the plastic tube and 71 cm² for the glass tube, the present carbon fibers increased the surface area for nucleation by at least 50 times. Another advantage of the carbon fibers apparent from the graphs is the increased speed of heat transfer in IPCM/CF for the same amount of latent heat (shown by a shorter solidification time and a smaller peak width than in pure IPCM).

Turning to the OPCMs, the effect of the present carbon fibers on the solidification process is more significant than that of the IPCMs. Rather than relying on external nucleation sites, as seen in the IPCM, OPCM changes phases from the liquid state to the solid state via self-nucleation, meaning they crystallize with little or no supercooling. As can be seen from the graph, OPCMs with and without carbon fibers began crystallization at about 4.3° C., which is the phase change temperature of the OPCM used. However, OPCM/CF started crystallization at about 3055 seconds, followed by a small recalescence peak (0.1° C.), while OPCM with no CF began to solidify at about 3310 seconds with a recalescence peak of 0.2° C. as shown in the magnified portion of FIG. 3. The recalescence peak width of OPCM/CF (i.e., 1500 seconds or 4555 minus 3055 seconds) was only about 21% of that of OPCM (i.e., 6720 seconds or 10030 minus 3310 seconds). Higher heat transfer of the carbon fibers caused the earlier completion of crystallization in the OPCM/CF. In this case, the large surface area of the present carbon fibers had no effect on the crystallization process, in which heterogenous crystallization played only a small role. Homogeneous crystallization was the controlling process in both OPCM and OPCM/CF. For OPCM, the high thermal conductivity of the present carbon fibers did not change the crystallization starting time, but shortened the total crystallization times by about 75-80% as estimated by the recalescence peak widths. Thus, the high thermal conductivity and anisotropy of the carbon fibers, when mixed with the PCMs, had a pronounced effect on solidification of the PCMs.

For both IPCM and OPCM, the effect of the long anisotropic carbon fibers on the solidification processes can be explained by the fiber's relatively high directional (anisotropic) thermal conductivity. There was no significant observed convection in either PCM (IPCM or OPCM) in the charging process that kept the PCM in ordered state with potential for absorbing heat from HTF. The IPCM's high viscosity and small difference in densities between solid and liquid states can explain its low convection behavior. The liquid OPCM's small temperature variations during the solidification process may cause little natural convection. As the solidification of the OPCM progressed from the tube wall, the thickening solid reduced the convection potential even further by reducing liquid volume or space.

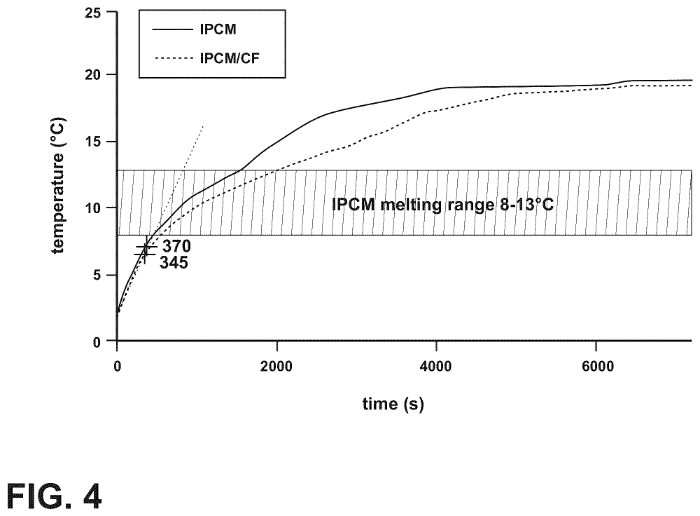

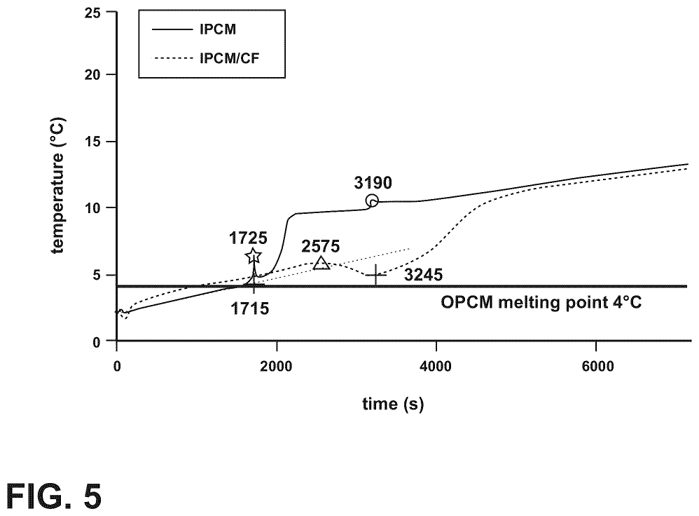

Next, melting of the PCMs was tested. The temperatures at the center of PCMs both with the long, anisotropic thermal conductive carbon fibers (present embodiments) and without carbon fibers (comparative examples) were measured during melting of the PCMs, and the results are shown in FIG. 4 (IPCMs) and FIG. 5 (OPCMs). As can be seen from the graphs, the melting process for the IPCMs occurred over a wide temperature range due to incongruent melting with phase separations. The starting and ending points were not easily determined by the temperature profiles. It is also difficult to do so by direct observation of the melting process because the melting front of salt hydrates is a mushy zone with no clear meniscus between liquid and solid phases. The linear section (shown in dashed line) at the beginning of the discharge profiles (heat transfer profile from fluid to PCM loaded vials) represent the sensible heating with solid PCMs and a slower ramping section represents the PCM melting and release of the latent heat. Therefore, deviation points of melting profile from the dashed black lines extrapolating from the solid heating sections were used to estimate the melting onset times. IPCM/CF (inorganic PCM with the long anisotropic carbon fibers) started melting at 345 seconds, slightly earlier than pure IPCM (inorganic PCM with no carbon fibers) at 370 seconds. FIG. 4 shows that during the melting process, the center temperature of IPCM/CF was lower than that of pure IPCM. The difference between the IPCM and IPCM/CF was caused by the fast heat transfer of the present carbon fibers. Increased temperatures above the melting point near the carbon fiber surfaces triggered the phase change and release of the latent heat, causing the temperature at the center of the tube samples to stagnate roughly between 1000 s and 4000 s.

Turning to the OPCMs, the congruent melting of the OPCMs resulted in a narrow melt temperature range around 4° C., which is shown by a dashed line in FIG. 5. The melt onset time for both OPCMs was hard to define in the center temperature profiles. Pure OPCM (organic phase change material with no carbon fiber) showed a sharp temperature increase at about 1715 seconds and OPCM/CF (organic PCM with long anisotropic carbon fibers) had a temperature rise starting at 3245 seconds, after which both center temperatures kept increasing quickly. One difference of OPCMs compared to IPCMs was their lower viscosity. It was observed that the solid OPCM always stayed at the bottom of the glass tube due to its higher density than that of the OPCM liquid. The sharp temperature increase after 1715 seconds for pure OPCM likely indicates the thermocouple lost touch of the solid material. While the solid portion remained at the bottom of the pure OPCM sample for its higher density, solids stayed suspended in the middle of the OPCM/CF bottle indicating that the addition of carbon fibers kept the solid OPCM from sinking to the bottom of the tube. The center temperature profile of OPCM also had a spike at 1725 seconds, which was related to the active flow of liquid OPCM near the tip of the solid OPCM. A later temperature spike for OPCM at 3190 seconds was likely related to the low-viscosity OPCM flow disturbance. An OPCM/CF center temperature drop shown at 3245 seconds in FIG. 5 was determined to be a decalescence point, when surrounding PCM melted quickly and absorbed a large amount of latent heat. From 2575 seconds to 3245 seconds, the heat flux at the center point changed direction from inward to outward based on the temperature drop. Decalescence in phase change materials is rarely observed, and the presence of decalescence in the melting process of OPCM/CF implies that the long anisotropic carbon fibers increased heat transfer in OPCM and caused a large volume of OPCM to melt. Decalescence would be favorable in a TES system, since it introduces more temperature difference and increases the heat transfer rate. In this decalescence, the temperature drop was 0.9° C.

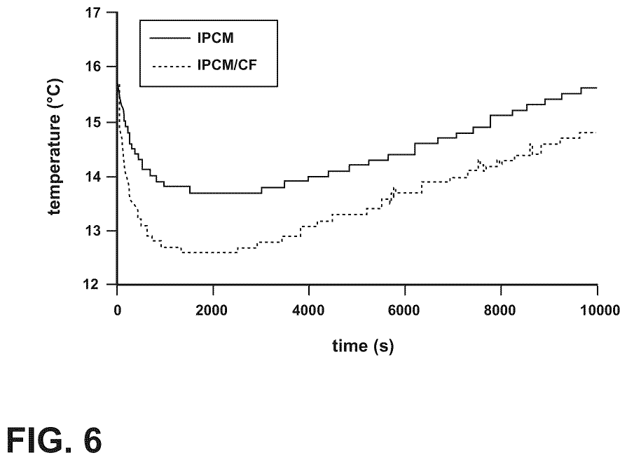

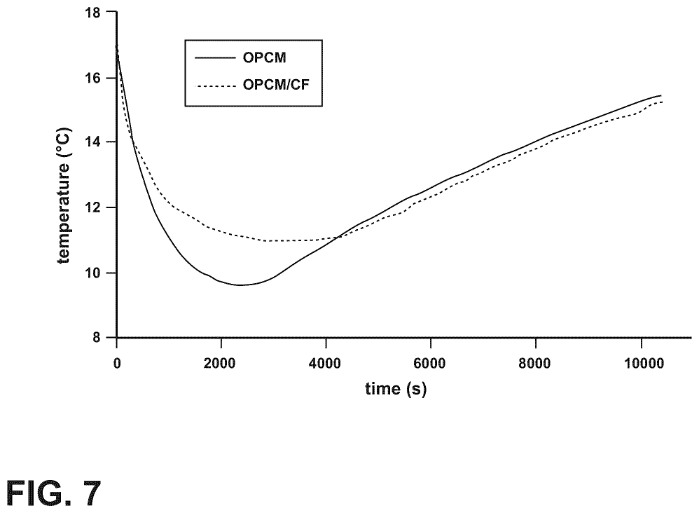

Thus, the melting process of the PCMs was also tested by comparing the temperature profiles of the beaker water. The results are shown in FIG. 6 (IPCMs) and FIG. 7 (OPCMs). The temperature measurements of the beaker water were taken simultaneously with the melt temperatures obtained and shown in FIGS. 4 and 5. In all the tests, the insulated beaker contained 300 mL of water. Assuming the average water temperature can be approximated by the measured water temperature at the middle point between the tube wall and the beaker wall, the total thermal output of the PCMs in the tubes can be evaluated by examining the temperature change of the water in the beaker. In this manner, the latent heat release rate from the PCMs is reflected in the beaker water temperature profile. The effects of the carbon fibers on the total thermal outputs of the PCMs is correlated with the beaker water temperature at the end of each test when all the PCM in the tube is melted. For the highly viscous IPCMs (both with carbon fiber (IPCM/CF) and without (IPCM), conduction was the only heat transfer mode. As indicated by the plots in the graph, the present carbon fibers kept the beaker water temperature about 1° C. lower (IPCM/CF) in comparison to IPCM (no carbon fibers) throughout the test. This result clearly indicates that the present carbon fibers increased the heat transfer between the PCM and water in the beaker.

Turning to the OPCMs, there are two heat transfer modes in pure liquid OPCM (conduction and convection), while in liquid OPCM/CF there is only one mode (conduction). In the OPCMs, the present carbon fibers formed a more uniform latent heat release for a longer time, resulting in a flatter temperature profile for the water in the beaker. Although the beaker water temperature with the OPCM/CF tube was higher than pure OPCM at the beginning, it was slightly lower after 4500 seconds. It is possible that natural convection in pure OPCM made significant contributions in the latent heat release before 4500 seconds and diminished thereafter due to the smaller temperature difference inside OPCM. In comparison, the present carbon fibers in OPCM/CF consistently and constantly contributed to enhancing thermal conduction. The effect of the carbon fibers on the latent heat release was smaller than that of the convection initially, but caught up at about 4500 seconds and surpassed that of the convection thereafter. Since natural convection is an important heat transfer mechanism in OPCMs, and the present carbon fibers may decrease fluidity, the thermal performance may be dependent upon the geometry of the container for the system.

The results of these experiments show that long, anisotropic thermal conductive carbon fibers with high thermal conductivities and high anisotropies enhance both the solidification and melting processes. The large surface area of the carbon fibers serves as a heat transfer interface for IPCMs in both the solidification and melting processes. The high anisotropy allowed the carbon fibers to act as fast heat transfer tunnels with a heat flux radially along the direction of the axis, making the whole fiber length thermally functional. The large surface area of the carbon fibers also acted as a heterogeneous nucleation site to quicken the solidification process. The carbon fibers improved the solidification of OPCMs in the same manner as with IPCMs, but for the melting process, the container design/geometry may also be a factor.

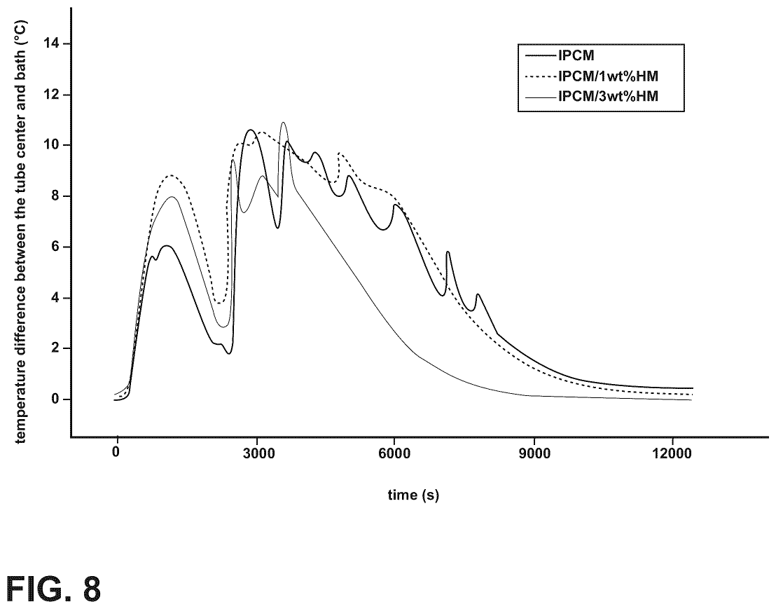

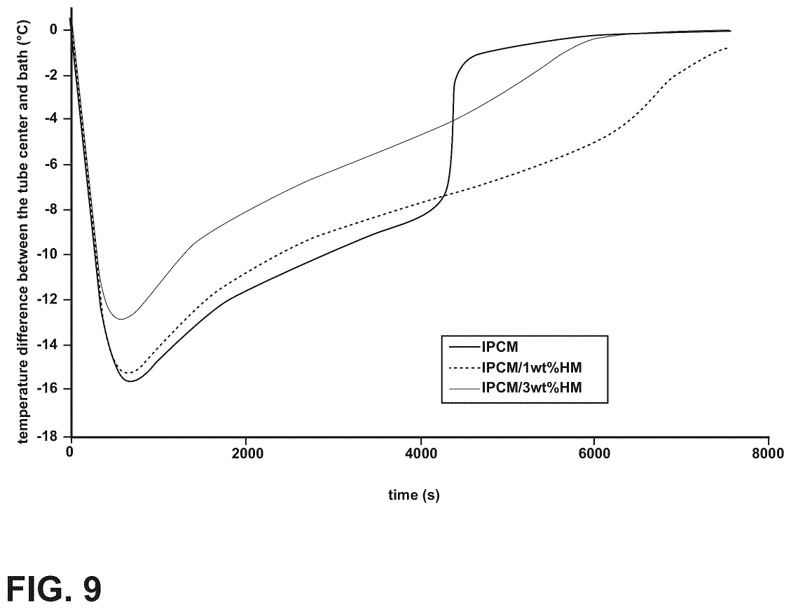

The effect of the present carbon fibers on the phase change of inorganic phase change materials was also tested for various loadings of various long, anisotropic thermal conductive carbon fibers. IPCMs were disposed in plastic tubes having a length of 10 inches and a diameter of 2 inches. Inorganic phase change material without the present carbon fibers (comparative example) was compared with IPCM with 1 wt. % HM63 anisotropic carbon fiber, and IPCM with 3 wt. % HM63 anisotropic carbon fiber. The temperature profiles for the charging sequences are shown in FIG. 8, and the temperature profiles for the discharging sequences are shown in FIG. 9. The results indicate that the full charging time sequences are the lowest for the 3 wt. % HM63 sample, followed by the 1 wt. % HM63 sample, and the pure OPCM (no carbon fiber) sample, in that order. The results also indicate that the full discharging time sequences are the lowest for the 3 wt. % HM63 sample, followed by the 1 wt. % HM63 sample, in that order. Hence, 3 wt. % of HM63 long, anisotropic thermal conductive carbon fibers had the best thermal performance with an inorganic phase change material in terms of charging and discharging times.

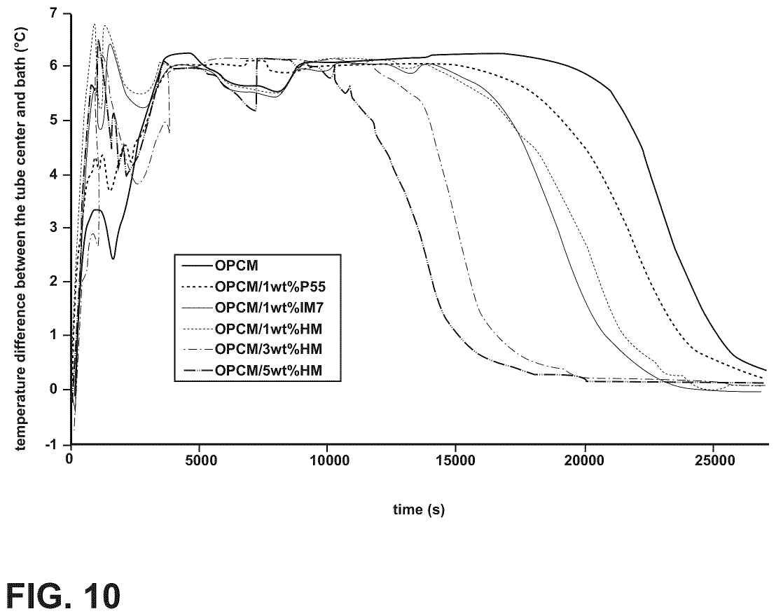

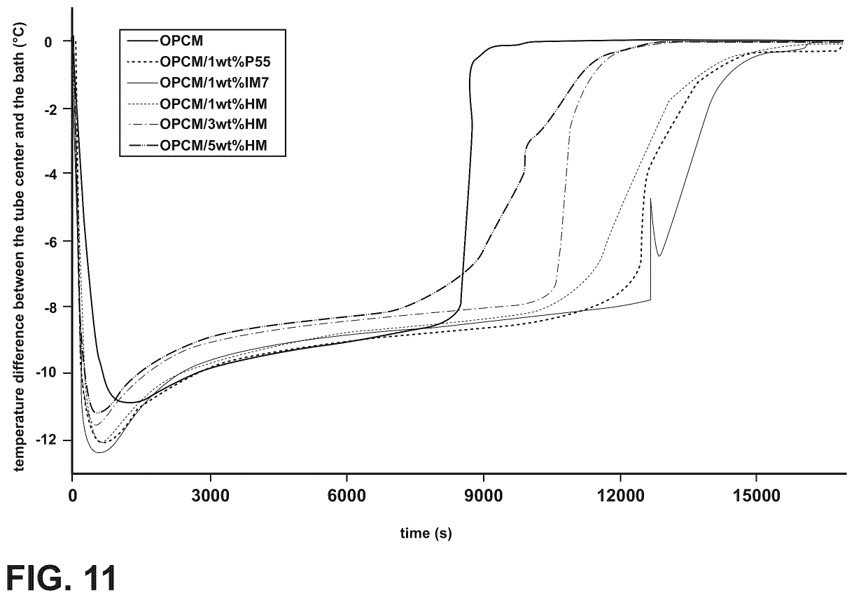

The effect of the present carbon fibers on the phase change of organic phase change materials was also tested for various loadings of various long, anisotropic thermal conductive carbon fibers. OPCMs were disposed in aluminum tubes having a length of 10 inches and a diameter of 2 inches. Organic phase change material without the present carbon fibers (comparative example) was compared with OPCM with 1 wt. % P55 isotropic carbon fiber (comparative example), OPCM with 1 wt. % IM7 anisotropic carbon fiber, OPCM with 1 wt. % HM63 anisotropic carbon fiber, OPCM with 3 wt. % HM63 anisotropic carbon fiber, and OPCM with 5 wt. % HM63 anisotropic carbon fiber. The temperature profiles for the charging sequences are shown in FIG. 10, and the temperature profiles for the discharging sequences are shown in FIG. 11. The results indicate that the full charging time sequences are the lowest for the 5 wt. % HM63 sample, followed by the 3 wt. % HM63 sample, the 1 wt. % HM63 sample, the 1 wt. % IM7 sample, the 1 wt. % P55 sample, and the pure OPCM (no carbon fiber) sample, in that order. The results also indicate that the full discharging time sequences are the lowest for the 5 wt. % HM63 sample, followed by the 3 wt. % HM63 sample, the 1 wt. % HM63 sample, the 1 wt. % IM7 sample, the 1 wt. % P55 sample, in that order. Hence, 5 wt. % of HM63 long, anisotropic thermal conductive carbon fibers had the best thermal performance in terms of charging and discharging times.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A thermal energy storage composition comprising:
a phase change material; and
a plurality of long, anisotropic thermal conductive carbon fibers mixed with the phase change material;
wherein the anisotropic thermal conductive carbon fibers increase the thermal storage efficiency of the composition.

2. The thermal energy storage composition of claim 1, wherein the phase change material is present in an amount of at least 95% by weight.

3. The thermal energy storage composition of claim 1, wherein the anisotropic thermal conductive carbon fibers are present in an amount of up to 5% by weight.

4. The thermal energy storage composition of claim 1, wherein the anisotropic thermal conductive carbon fibers have a length in the range of 1 to 10 cm.

5. The thermal energy storage composition of claim 1, wherein the phase change material has a thermal conductivity in the range of 0.1 to 0.6 W/(m·K).

6. The thermal energy storage composition of claim 5, wherein the thermal conductivity of the composition is greater than the thermal conductivity of the phase change material.

7. The thermal energy storage composition of claim 1, wherein the anisotropic thermal conductive carbon fibers have a greater thermal conductivity in an axial direction relative to a thermal conductivity in a radial direction.

8. The thermal energy storage composition of claim 7, wherein the thermal conductivity in the axial direction is in a range of 2-200 W/(m·K), and the thermal conductivity in the radial direction is in a range of 0.5-50 W/(m·K).

9. The thermal energy storage composition of claim 7, wherein the thermal conductivity in the axial direction is approximately 2-10 times greater than the thermal conductivity in the radial direction.

10. The thermal energy storage composition of claim 1, wherein the phase change material is an organic phase change material or an inorganic phase change material.

11. A thermal energy storage system comprising:
a container;
a phase change material disposed within the container; and
a plurality of long, anisotropic thermal conductive carbon fibers mixed with the phase change material in the container;
wherein the anisotropic thermal conductive carbon fibers increase the effective thermal conductivity of the system, thereby accelerating phase change of the phase change material to reduce charge and discharge times of the thermal storage system.

12. The thermal energy storage system of claim 11, wherein the phase change material is present in an amount of at least 95% by weight.

13. The thermal energy storage system of claim 11, wherein the anisotropic thermal conductive carbon fibers are present in an amount of up to 5% by weight.

14. The thermal energy storage system of claim 11, wherein the anisotropic thermal conductive carbon fibers have a length in the range of 1 to 10 cm.

15. The thermal energy storage system of claim 11, wherein the phase change material has a thermal conductivity in the range of 0.1 to 0.6 W/(m·K).

16. The thermal energy storage system of claim 15, wherein the thermal conductivity of the composition is greater than the thermal conductivity of the phase change material.

17. The thermal energy storage system of claim 11, wherein the anisotropic thermal conductive carbon fibers have a greater thermal conductivity in an axial direction relative to a thermal conductivity in a radial direction.

18. The thermal energy storage system of claim 17, wherein the thermal conductivity in the axial direction is in a range of 2-200 W/(m·K), and the thermal conductivity in the radial direction is in a range of 0.5-50 W/(m·K).

19. The thermal energy storage system of claim 17, wherein the thermal conductivity in the axial direction is approximately 2-10 times greater than the thermal conductivity in the radial direction.

20. The thermal energy storage system of claim 11, wherein the phase change material is an organic phase change material or an inorganic phase change material.

21. The thermal energy storage system of claim 11, wherein the container is cylindrical in shape.

22. The thermal energy storage system of claim 11, wherein the container storing the phase change material and anisotropic thermal conductive carbon fibers defines a module, and the thermal energy storage system comprises a plurality of said modules.

23. The thermal energy storage system of claim 11, wherein a working temperature of the system is in a range of from −50° C. to 700° C.

24. A method of heat management in a thermal energy storage system, the method comprising:
providing the thermal energy storage composition of claim 1;
disposing the thermal energy storage composition within a container; and
flowing a heat exchange medium over the container, wherein thermal energy is exchanged between the heat exchange medium and the thermal energy storage composition;
wherein the anisotropic thermal conductive carbon fibers increase the effective thermal conductivity of the mixture, thereby accelerating phase change of the phase change material to reduce charge and discharge times of the thermal storage system.
